(19) United States
(12) Patent Application Publication
(10) Pub. No.: US 2024/0328985 A1
(43) Pub. Date: Oct. 3, 2024

(54) ELECTRODE SUBSTRATE

(71) Applicant: Murata Manufacturing Co., Ltd., Nagaokakyo-shi (JP)

(72) Inventors: Naruto MIYAKAWA, Nagaokakyo-shi (JP); Ayumi SHINAGAWA, Nagaokakyo-shi (JP); Tomomi NAKANO, Nagaokakyo-shi (JP); Shota USHIBA, Nagaokakyo-shi (JP); Shinsuke TANI, Nagaokakyo-shi (JP)

(21) Appl. No.: 18/678,044

(22) Filed: May 30, 2024

Related U.S. Application Data
(63) Continuation of application No. PCT/JP2022/042877, filed on Nov. 18, 2022.

(30) Foreign Application Priority Data
Dec. 3, 2021 (JP) 2021-196855

(51) Int. Cl. G01N 27/30; G01N 27/327; H01B 1/02; H01B 5/16

(52) U.S. Cl. CPC G01N 27/301; H01B 1/02; H01B 5/16; G01N 27/3271

(57) ABSTRACT

An electrode substrate includes an insulation substrate and a reference electrode on the insulation substrate. The reference electrode includes a silver layer, a first silver chloride layer, and a second silver chloride layer. The silver layer is on the insulation substrate. The first silver chloride layer is on the silver layer on the insulation substrate, and covers the silver layer. The second silver chloride layer is on the first silver chloride layer on the insulation substrate, and covers the first silver chloride layer. An area void fraction of the first silver chloride layer is larger than an area void fraction of the second silver chloride layer in any longitudinal section.

### CROSS REFERENCE TO RELATED APPLICATIONS

This application claims the benefit of priority to Japanese Patent Application No. 2021-196855 filed on Dec. 3, 2021 and is a Continuation Application of PCT Application No. PCT/JP2022/042877 filed on Nov. 18, 2022. The entire contents of each application are hereby incorporated herein by reference.

### BACKGROUND OF THE INVENTION

### 1. Field of the Invention

The present invention relates to electrode substrates.

### 2. Description of the Related Art

Japanese Unexamined Patent Application Publication No. 2005-292022 discloses a method of manufacturing a reference electrode as a prior art document. The reference electrode described in Japanese Unexamined Patent Application Publication No. 2005-292022 includes a conductive pattern formed on an insulation substrate and a composite body containing silver formed on a reference electrode portion of the conductive pattern, and a surface of the composite body is formed of a silver chloride layer.

Because silver chloride has a higher thermal expansion coefficient than a material of an insulation substrate and silver, stress concentrates at an interface between the insulation substrate and a silver chloride layer when the temperature changes, and a reference electrode may be separated from the insulation substrate.

### SUMMARY OF THE INVENTION

Example embodiments of the present invention provide electrode substrates in each of which separation of a reference electrode from an insulation substrate is reduced or prevented.

An electrode substrate according to an example embodiment of the present invention includes an insulation substrate and a reference electrode. The reference electrode is on the insulation substrate. The reference electrode includes a silver layer, a first silver chloride layer, and a second silver chloride layer. The silver layer is on the insulation substrate. The first silver chloride layer is on the silver layer and covers the silver layer. The second silver chloride layer is on the first silver chloride layer and covers the first silver chloride layer. An area void fraction of the first silver chloride layer is larger than an area void fraction of the second silver chloride layer in any longitudinal section.

According to example embodiments of the present invention, separation of a reference electrode from an insulation substrate is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view of an electrode substrate according to an example embodiment of the present invention illustrating a structure thereof.

FIG. 2 is a sectional view of the electrode substrate in FIG. 1 taken along line II-II in a direction of arrows.

FIG. 3 is a perspective view of a graphene transistor including an electrode substrate according to an example embodiment of the present invention schematically illustrating a structure thereof.

FIG. 4 is a photograph of a longitudinal section of a reference electrode of an electrode substrate according to an example embodiment of the present invention, which is enlarged and captured under a scanning electron microscope.

FIG. 5 is a photograph in which a portion V in FIG. 4 is further enlarged and captured.

FIG. 6 is a partial longitudinal sectional view of a reference electrode according to a comparative example illustrating a distribution of shear stress generated when the temperature changes from about 20° C. to about 100° C.

FIG. 7 is a partial longitudinal sectional view of a reference electrode according to an example embodiment illustrating a distribution of shear stress generated when the temperature changes from about 20° C. to about 100° C.

FIG. 8 is a graph describing a transition of shear stress at a position in AA′ with a point A being the origin, along an interface between the insulation substrate and the silver chloride layer illustrated in FIG. 6 and FIG. 7.

### DETAILED DESCRIPTION OF THE EXAMPLE EMBODIMENTS

Hereinafter, electrode substrates according to example embodiments of the present invention will be described with reference to the drawings. In the following description of example embodiments, the same or corresponding portions in the drawings are denoted by the same reference signs, and a description thereof will not be repeated.

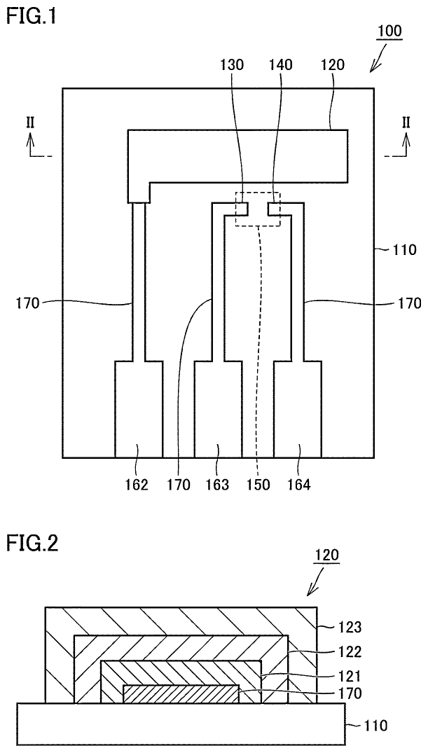

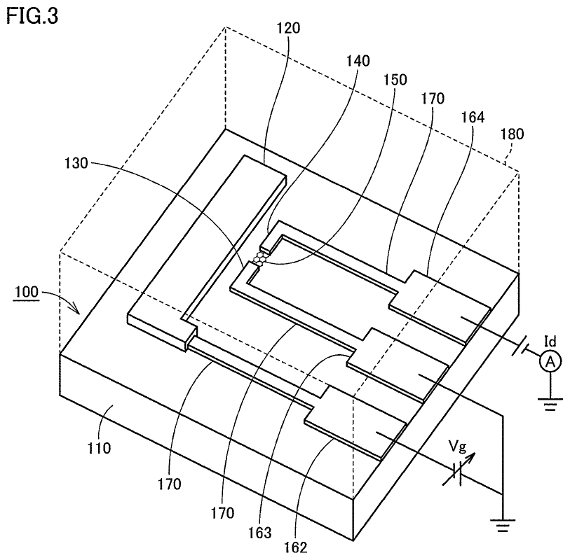

FIG. 1 is a plan view of an electrode substrate according to an example embodiment of the present invention illustrating a structure thereof. FIG. 2 is a sectional view of the electrode substrate in FIG. 1 viewed from a direction of arrows taken along line II-II. As illustrated in FIG. 1 and FIG. 2, an electrode substrate 100 according to the present example embodiment of the present invention includes an insulation substrate 110 and a reference electrode 120. The reference electrode 120 is provided on the insulation substrate 110. The electrode substrate 100 further includes a metal wiring layer 170 provided on the insulation substrate 110.

As a material of the insulation substrate 110, for example, a semiconductor such as silicon or germanium, glass such as quartz glass, lead glass, or borosilicate glass, ceramics, a resin, or the like can be used.

As a resin material of the insulation substrate 110, for example, polystyrene (PS), polypropylene (PP), polyimide (PI), polytetrafluoroethylene (PTFE), polyphenylene sulfide (PPS), polyether ether ketone (PEEK), polyethylene terephthalate (PET), polymethyl methacrylate (PMMA), polyethylene-2, 6-naphthalate (PEN), or the like may be used. As described later, when the metal wiring layer is made of, for example, gold, the insulation substrate 110 is preferably made of, for example, polyethylene terephthalate, which has high adhesiveness to gold.

In the present example embodiment, for example, the insulation substrate 110 is made of silicon, and a SiO₂ film is provided on a surface of the insulation substrate 110.

As a material of the metal wiring layer 170, for example, a noble metal such as gold, platinum, or palladium, carbon, or the like may be used. From the viewpoint of stability of a surface state, the metal wiring layer 170 is preferably made of, for example, gold.

An example of a method of forming the metal wiring layer 170 may be as follows. First, a conductive material is applied on the entire or substantially entire surface of the insulation substrate 110 by, for example, printing, sputtering, or vapor deposition. Thereafter, the conductive material is partially removed by, for example, etching or laser to form a wiring pattern, or a wiring pattern is formed on the insulation substrate 110 by, for example, sputtering using a mask.

In the present example embodiment, the surface of the SiO₂ film, at a position where the metal wiring layer 170 is to be formed, is removed to be made thinner, a titanium layer is formed at the portion, and a gold layer is formed on the titanium layer. That is, the metal wiring layer 170 is formed of a laminated structure of the titanium layer and the gold layer. A thickness of the titanium layer is about 10 nm, for example. A thickness of the gold layer is about 90 nm, for example.

As illustrated in FIG. 1, a first coupling terminal 162, a second coupling terminal 163, a third coupling terminal 164, a first electrode 130, and a second electrode 140 are each formed by the patterned metal wiring layer 170. Each of the first coupling terminal 162, the second coupling terminal 163, and the third coupling terminal 164 is formed along an edge of the insulation substrate 110, and may be electrically coupled to an external terminal.

The first coupling terminal 162 is coupled to the reference electrode 120. The second coupling terminal 163 is coupled to the first electrode 130. The third coupling terminal 164 is coupled to the second electrode 140. The first electrode 130 and the second electrode 140 face each other with a space therebetween. The first electrode 130 and the second electrode 140 are configured such that they may electrically be coupled to each other through a transmission path 150.

In the present example embodiment, the transmission path 150 is formed of a semiconductor channel. Specifically, the transmission path 150 is formed of, for example, graphene. A pair of electrodes including the first electrode 130 and the second electrode 140 includes a junction with the semiconductor channel formed in or on the insulation substrate 110. The transmission path 150 is not limited to a semiconductor channel, and may be, for example, a solution such as blood disposed on the electrode substrate 100. In the above case, the electrode substrate 100 may be applied to an enzyme sensor such as a glucose sensor, for example.

As illustrated in FIG. 1 and FIG. 2, for example, the reference electrode 120 includes the metal wiring layer 170, a silver layer 121, a first silver chloride layer 122, and a second silver chloride layer 123.

The silver layer 121 is provided on the metal wiring layer 170 on the insulation substrate 110, and covers at least a portion of the metal wiring layer 170. A portion of the silver layer 121 is provided on the insulation substrate 110. The silver layer 121 is a plating film formed by electrolytic plating, for example. A thickness of the silver layer 121 is about 3 μm, for example.

As illustrated in FIG. 1, the silver layer 121 covers only a portion of the metal wiring layer 170. A portion of the metal wiring layer 170 not covered by the silver layer 121 defines a pair of electrodes including the first electrode 130 and the second electrode 140 provided on the insulation substrate 110.

The first silver chloride layer 122 is provided on the silver layer 121 on the insulation substrate 110, and covers the silver layer 121. A portion of the first silver chloride layer 122 is provided on the insulation substrate 110.

The second silver chloride layer 123 is provided on the first silver chloride layer 122 on the insulation substrate 110, and covers the first silver chloride layer 122. A portion of the second silver chloride layer 123 is provided on the insulation substrate 110.

The first silver chloride layer 122 and the second silver chloride layer 123 are formed by, for example, immersing a silver plating film in hypochlorous acid. The first silver chloride layer 122 and the second silver chloride layer 123 may be formed by, for example, immersing the silver plating film in another oxidizing agent containing chlorine instead of the hypochlorous acid. Thus, the silver layer 121, the first silver chloride layer 122, and the second silver chloride layer 123 are formed of one silver plating film.

The reference electrode 120 may be formed by, for example, sequentially laminating the silver layer 121, the first silver chloride layer 122, and the second silver chloride layer 123 one by one. Specifically, for example, a solvent containing a silver/silver chloride particle is applied to the corresponding portion by dispenser coating or spin coating, and by volatilizing the solvent, the silver chloride layer may be obtained. At this time, a member that volatilizes at a relatively low temperature, such as a resin bead, for example, is mixed with the solvent and applied, and then a portion filled with the resin is made into a void by a heat treatment, such that the first silver chloride layer 122 may be formed. Further, by forming a silver chloride layer with a heat treatment without adding a resin bead to the solvent, the second silver chloride layer 123 may be obtained. Alternatively, when a similar structure is obtained, the first silver chloride layer 122 and the second silver chloride layer 123 may sequentially be laminated one by one by, for example, sputtering or a vapor deposition method.

As described later, an area void fraction of the first silver chloride layer 122 is larger than an area void fraction of the second silver chloride layer 123 in any longitudinal section. A total thickness of the first silver chloride layer 122 and the second silver chloride layer 123 is about 20 μm or less, for example. A ratio of a thickness of the first silver chloride layer 122 to the total thickness of the first silver chloride layer 122 and the second silver chloride layer 123 is about 20% or more, for example. In the present example embodiment, the total thickness of the first silver chloride layer 122 and the second silver chloride layer 123 is about 10 μm, for example. The ratio of the thickness of the first silver chloride layer 122 to the total thickness of the first silver chloride layer 122 and the second silver chloride layer 123 is about 50%, for example.

FIG. 3 is a perspective view of a graphene transistor including the electrode substrate according to the present example embodiment of the present invention schematically illustrating a structure thereof. As illustrated in FIG. 3, in the graphene transistor, an electrolytic solution 180 is disposed on the electrode substrate 100. The transmission path 150 defined by graphene in or on the surface layer portion of the insulation substrate 110 is in contact with the electrolytic solution 180. The first electrode 130 defines and functions as a source electrode, and the second electrode 140 defines and functions as a drain electrode. The reference electrode 120 is provided to control electric potential of the electrolytic solution 180.

A power source to apply a gate voltage Vg is coupled to the first coupling terminal 162. The second coupling terminal 163 is grounded. A power source to apply a voltage between the source electrode and the drain electrode is coupled to the third coupling terminal 164.

With the above structure, in the graphene transistor, the electric conductivity of graphene may be modulated by application of an electric field to the graphene through an electric double layer of the electrolytic solution 180.

A biosensor or a chemical sensor may include the graphene transistor. Specifically, a receptor or a functional film, which peculiarly bonds to a target molecule as a measuring target, is provided on the graphene. The electric conductivity of the graphene is modulated by an electric charge of the target molecule bonded to a surface of graphene, and thus the presence or absence of a molecule being a measuring target or the density of a molecule in a solution may be measured.

Hereinafter, the configuration of the reference electrode 120 of the electrode substrate 100 according to the present example embodiment of the present invention will be described in detail.

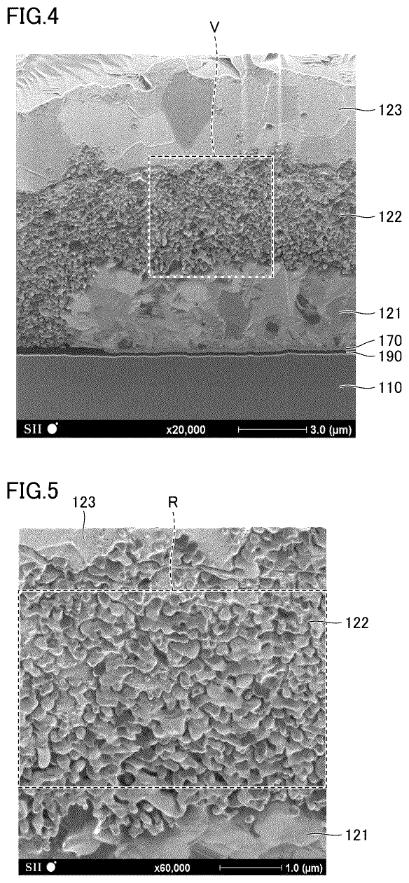

FIG. 4 is a photograph of a longitudinal section of the reference electrode of the electrode substrate according to the present example embodiment of the present invention, which is enlarged and captured under a scanning electron microscope. FIG. 5 is a photograph in which a portion V in FIG. 4 is further enlarged and captured.

As illustrated in FIG. 4 and FIG. 5, a SiO₂ film 190 is provided on the surface of the insulation substrate 110, and the metal wiring layer 170 is provided on the SiO₂ film 190. The silver layer 121, the first silver chloride layer 122, and the second silver chloride layer 123 are laminated in this order on the metal wiring layer 170. The silver layer 121 is made of, for example, a polycrystal.

The first silver chloride layer 122 is made of, for example, a porous body including a large number of small crystallites and voids. The area void fraction of the first silver chloride layer 122 is, for example, about 10% or more. The area void fraction of the first silver chloride layer 122 in a region R illustrated in FIG. 5, which was derived using image analysis software “A-zou kun” (registered trademark) developed by Asahi Kasei Engineering Corporation, was, for example, about 13%.

The second silver chloride layer 123 is made of, for example, a polycrystal having an average grain size of about 1 μm or more. The second silver chloride layer 123 has a dense structure in which large crystallites are combined. As can be seen in FIG. 4 and FIG. 5, the area void fraction of the first silver chloride layer 122 is larger than the area void fraction of the second silver chloride layer 123 in any longitudinal section.

The following chemical reactions are considered as a mechanism to form the first silver chloride layer 122 and the second silver chloride layer 123. By immersing the silver plating film in hypochlorous acid, silver positioned in a surface portion of the plating film is eluted, and silver chloride containing a large number of voids is formed in the surface portion. The above portion becomes the first silver chloride layer 122. The silver eluted from the surface portion becomes high density silver chloride in the vicinity of the surface portion and is precipitated to an outer side portion of the surface portion. The above portion becomes the second silver chloride layer 123. As a result, the silver plating film becomes a laminated structure of the silver layer 121, the first silver chloride layer 122, and the second silver chloride layer 123 with volume expansion.

TABLE 1

| | Thermal expansion | Young's | Poisson's |
|---|---|---|---|
| Material | coefficient (/° C.) | modulus (GPa) | ratio |
| Si | 4.15 × 10⁻⁶ | 131 | 0.266 |
| SiO₂ | 0.55 × 10⁻⁶ | 72 | 0.17 |
| Au | 14.2 × 10⁻⁶ | 78 | 0.44 |
| Ag | 19.7 × 10⁻⁶ | 82.7 | 0.367 |
| AgCl (second | 31 × 10⁻⁶ | 20 | 0.4 |
| silver chloride | | | |
| layer) | | | |
| AgCl (first | 15 × 10⁻⁶ | 10 | 0.4 |
| silver chloride | | | |
| layer) | | | |

Physical property values of materials of the electrode substrate 100 are described in Table 1. For the first silver chloride layer, neither physical property values nor evaluation values are described, and instead, values of a small thermal expansion coefficient and a small Young's modulus are described in consideration of the inclusion of voids. Qualitatively, a thermal stress relaxation effect is provided as long as the first silver chloride layer has a smaller thermal expansion coefficient and a smaller Young's modulus than those of the second silver chloride layer. Further, as long as the thermal stress relaxation effect is provided, it is sufficient that either the thermal expansion coefficient or the Young's modulus of the first silver chloride layer is smaller than that of the second silver chloride layer.

Here, the results simulation analysis distribution of shear stress generated when the temperature changes from about 20° C. to about 100° C. will be described for a reference electrode according to a comparative example and the reference electrode according to the present example embodiment. In the reference electrode according to the comparative example, no first silver chloride layer 122 is provided because the second silver chloride layer 123 is also provided in a portion of the first silver chloride layer 122.

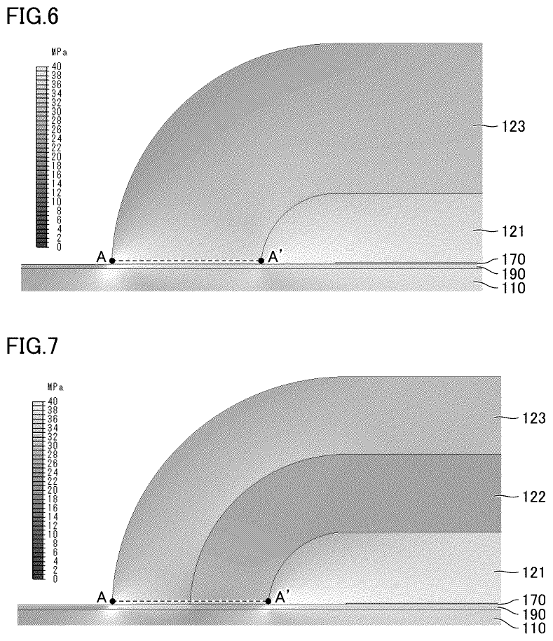

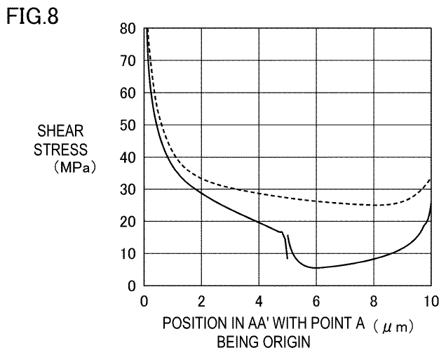

FIG. 6 is a partial longitudinal sectional view of the reference electrode according to the comparative example illustrating a distribution of shear stress generated when the temperature changes from about 20° C. to about 100° C. FIG. 7 is a partial longitudinal sectional view of the reference electrode according to the present example embodiment illustrating a distribution of shear stress generated when the temperature changes from about 20° C. to about 100° C. FIG. 8 is a graph describing a transition of shear stress at a position in AA′ with a point A being the origin along an interface between the insulation substrate and the silver chloride layer illustrated in FIG. 6 and FIG. 7. In FIG. 8, a vertical axis represents shear stress (MPa), and a horizontal axis represents position (μm) in AA′ with the point A being the origin. The transition of the reference electrode according to the comparative example is indicated by a dotted line, and the transition of the reference electrode according to the present example embodiment is indicated by a solid line.

As illustrated in FIG. 6 and FIG. 7, the shear stress generated when the temperature changes from about 20° C. to about 100° C. in the reference electrode according to the present example embodiment is lower than that in the reference electrode according to the comparative example. This is because stress concentration at the interface between the insulation substrate 110 and the silver chloride layer is relaxed by small thermal expansion amount of the first silver chloride layer 122, and deformation of the first silver chloride layer 122, having a small Young's modulus, due to expansion of the second silver chloride layer 123.

From the above-described simulation analysis results, it is confirmed that when the reference electrode 120 includes the first silver chloride layer 122, stress concentration at the interface between the insulation substrate 110 and the silver chloride layer is relaxed, and the separation of the reference electrode 120 from the insulation substrate 110 may be reduced or prevented.

The electrode substrate 100 according to the present example embodiment of the invention present includes the insulation substrate 110 and the reference electrode 120. The reference electrode 120 is provided on the insulation substrate 110. The reference electrode 120 includes the silver layer 121, the first silver chloride layer 122, and the second silver chloride layer 123. The silver layer 121 is provided on the insulation substrate 110. The first silver chloride layer 122 is provided on the silver layer 121 on the insulation substrate 110, and covers the silver layer 121. The second silver chloride layer 123 is provided on the first silver chloride layer 122 on the insulation substrate 110, and covers the first silver chloride layer 122. The area void fraction of the first silver chloride layer 122 is larger than the area void fraction of the second silver chloride layer 123 in any longitudinal section. As a result, the separation of the reference electrode 120 from the insulation substrate 110 may be reduced or prevented.

The area void fraction of the first silver chloride layer 122 is, for example, about 10% or more in the electrode substrate 100 according to the present example embodiment of the present invention. As a result, stress concentration at the interface between the insulation substrate 110 and the silver chloride layer may be relaxed by the deformation of the first silver chloride layer 122 while reducing the thermal expansion amount of the first silver chloride layer 122 when the temperature changes.

The ratio of the thickness of the first silver chloride layer 122 to the total thickness of the first silver chloride layer 122 and the second silver chloride layer 123 is, for example, about 20% or more in the electrode substrate 100 according to the present example embodiment of the present invention. As a result, the stress relaxation effect by the first silver chloride layer 122 may be sufficiently ensured.

The total thickness of the first silver chloride layer 122 and the second silver chloride layer 123 is, for example, about 20 μm or less in the electrode substrate 100 according to the present example embodiment of the present invention. As a result, the magnitude of shear stress generated at the interface between the insulation substrate 110 and the silver chloride layer, when the temperature changes, may be made smaller.

The second silver chloride layer 123 is made of, for example, a polycrystal having an average grain size of about 1 μm or more in the electrode substrate 100 according to the present example embodiment of the present invention. As a result, the reference electrode 120 may be made robust as a bulk body.

The electrode substrate 100 according to the present example embodiment of the present invention further includes the metal wiring layer 170 provided on the insulation substrate 110, and the silver layer 121 is provided on the metal wiring layer 170 on the insulation substrate 110 to cover at least a portion of the metal wiring layer 170. As a result, the silver layer 121 may be in close contact with the insulation substrate 110 with the metal wiring layer 170 interposed therebetween.

The silver layer 121 is made of, for example, a polycrystal in the electrode substrate 100 according to the present example embodiment of the present invention. As a result, the silver layer 121 may be made robust as a bulk body.

The silver layer 121 is, for example, a plating film in the electrode substrate 100 according to the present example embodiment of the present invention. As a result, the silver layer 121 may be in close contact with the insulation substrate 110 with the metal wiring layer 170 interposed therebetween.

The silver layer 121 covers only a portion of the metal wiring layer 170 in the electrode substrate 100 according to the present example embodiment of the present invention. The portion of the metal wiring layer 170 not covered by the silver layer 121 defines a pair of electrodes provided on the insulation substrate 110. As a result, the reference electrode 120, and the first electrode 130 and the second electrode 140 being the pair of electrodes may be integrated on the insulation substrate 110.

The pair of electrodes includes a junction with a semiconductor channel provided in or on the insulation substrate 110 in the electrode substrate 100 according to the present example embodiment of the present invention. As a result, the reference electrode 120 and a sensor portion including the semiconductor channel may be integrated on the insulation substrate 110.

In the description of the above-described example embodiments of the present invention, configurations that can be combined may be combined with each other.

The reference electrode 120 and the sensor portion including the semiconductor channel are integrated on the insulation substrate 110 in the electrode substrate 100. However, a counter electrode or other elements may further be integrated on the same insulation substrate 110.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electrode substrate, comprising:
an insulation substrate; and
a reference electrode on the insulation substrate; wherein the reference electrode includes:
a silver layer on the insulation substrate;
a first silver chloride layer on the silver layer and covering the silver layer;
a second silver chloride layer on the first silver chloride layer and covering the first silver chloride layer; and
an area void fraction of the first silver chloride layer is larger than an area void fraction of the second silver chloride layer in any longitudinal section.

2. The electrode substrate according to claim 1, wherein the area void fraction of the first silver chloride layer is about 10% or more.

3. The electrode substrate according to claim 1, wherein a ratio of a thickness of the first silver chloride layer to a total thickness of the first silver chloride layer and the second silver chloride layer is about 20% or more.

4. The electrode substrate according to claim 1, wherein a total thickness of the first silver chloride layer and the second silver chloride layer is about 20 μm or less.

5. The electrode substrate according to claim 1, wherein the second silver chloride layer is made of a polycrystal with an average grain size of about 1 μm or more.

6. The electrode substrate according to claim 1, further comprising:
a metal wiring layer on the insulation substrate; wherein
the silver layer is provided on the metal wiring layer on the insulation substrate and covers at least a portion of the metal wiring layer.

7. The electrode substrate according to claim 6, wherein the silver layer is made of a polycrystal.

8. The electrode substrate according to claim 6, wherein the silver layer is a plating film.

9. The electrode substrate according to claim 6, wherein
the silver layer covers only a portion of the metal wiring layer; and
a portion of the metal wiring layer not covered with the silver layer defines a pair of electrodes on the insulation substrate.

10. The electrode substrate according to claim 9, wherein the pair of electrodes include junction with a semiconductor channel provided in or on the insulation substrate.

11. The electrode substrate according to claim 1, wherein the insulation substrate includes at least one of silicon, germanium, quartz glass, lead glass, borosilicate glass, a ceramic, or a resin.

12. The electrode substrate according to claim 1, wherein the insulation substrate includes silicon and a SiO₂ film on the silicon.

13. The electrode substrate according to claim 6, wherein the metal wiring layer includes at least one of gold, platinum, palladium, or carbon.

14. The electrode substrate according to claim 1, wherein the insulation substrate includes at least one of polystyrene, polypropylene, polyimide, polytetrafluoroethylene, polyphenylene sulfide, polyether ether ketone, polyethylene terephthalate, polymethyl methacrylate, polyethylene-2, or 6-naphthalate.

15. The electrode substrate according to claim 1, wherein a thickness of the silver layer is about 3 μm.

16. The electrode substrate according to claim 1, wherein the silver layer, the first silver chloride layer, and the second silver chloride layer are defined by one silver plating layer.

17. The electrode substrate according to claim 4, wherein the total thickness of the first silver chloride layer and the second silver chloride layer is about 10 μm.

18. The electrode substrate according to claim 3, wherein the ratio of the thickness of the first silver chloride layer to the total thickness of the first silver chloride layer and the second silver chloride layer is about 50%.
